(19) United States
(12) Patent Application Publication
(10) Pub. No.: US 2007/0192833 A1
(43) Pub. Date: Aug. 16, 2007

(54) System and method for configuring an electronic device to access to a wireless local area network

(75) Inventors: Chi-Fan Ho, Taipei (TW); Jeng-Chun Chen, Taipei (TW)

Correspondence Address: BACON & THOMAS, PLLC, 625 SLATERS LANE, FOURTH FLOOR, ALEXANDRIA, VA, 22314, US

(73) Assignee: Arcadyan Technology Corporation, Hsinchu (TW)

(21) Appl. No.: 11/340,634

(22) Filed: Jan. 27, 2006

(51) Int. Cl. H04L 9/32

(52) U.S. Cl. 726/3; 380/270; 340/5.74; 713/168

(57) ABSTRACT

A system and method for configuring an electronic device to access a wireless local area network. The system includes a wireless access point device and an electronic device. The wireless access point device includes a control circuit and a first media port. The control circuit is used for controlling the wireless access point device and generating security data, and the first media port is for outputting the security data. The electronic device includes a second media port and a data processing circuit. When the second media port is electrically connected to the first media port, the electronic device, through the second media port, receives the security data. The data processing circuit configures the electronic device according to the security data in order to wirelessly access the wireless local area network via the wireless access point device.

### BACKGROUND OF THE INVENTION

1. Field of the Invention

The invention relates in general to a wireless local area network and a method for configuring the same, and more particularly to a system and method for configuring an electronic device to communicate with a wireless local area network.

2. Description of the Related Art

Referring to FIG. 1, a typical wireless local area network (WLAN) 10 is illustrated in infrastructure mode. The wireless local area network 10 includes a client device, such as a notebook computer 120, and a wireless access point (AP) 110, which may be connected to a wired local area network or Internet (not shown). The user needs to configure the notebook computer 120 with security information, such as service set identifier (SSID), wired equivalent privacy (WEP) key, or Wi-Fi protected access (WPA) key, to enable the notebook computer 120 to access the WLAN 10 via the AP 110 wirelessly.

User authentication is specifically required for the notebook computer 120 before the notebook computer 120 communicates with the WLAN 10 via the access point 110. In general, user authentication requires the user to input security information, for example, an SSID, WEP key or WPA key, into the notebook computer 120 in order to identify whether the notebook computer 120 is an authorized client. The security information inputted by the user is then transmitted to the AP 110. After the user authentication is completed and indicates that the user is authorized, the AP 110 enables the notebook computer 120 to access the WLAN 10.

However, entering the security information during user authentication is inconvenient. With this inconvenience, a client device, for example, a wireless audio/video device, would be difficult for a user to configure and use. Besides, it is not secure to enter and transmit the security information during the process of user authentication because wireless sniffing tools are easily available to ones who intend for capturing others secret information. Thus, it is desirable to have a mechanism for configuring the client device to communicate with a WLAN via an AP in a secure and simple manner.

### SUMMARY OF THE INVENTION

It is therefore an object of the invention to provide a system and method for configuring an electronic device to communicate with a wireless local area network (WLAN) via a wireless access point (AP). By making a wired connection between the electronic device and the AP, the electronic device acquires security data for access to a WLAN from the AP automatically, and then automatically configures itself for access to the WLAN according to the acquired security data.

The invention achieves the above-identified object by providing an electronic device to access a wireless local area network via a wireless access point device. The electronic device includes a media port and a data processing circuit. The media port is in a normal mode for media data and in a set-up mode selectively operable. When the media port is electrically connected to the wireless access point device in the set-up mode, the electronic device, through the media port, receives a signal indicating security data generated by the wireless access point device, wherein the security data include an identifier for authentication between the electronic device and the wireless access point device. The data processing circuit is used for configuring the electronic device according to the security data to wirelessly access the wireless local area network via the wireless access point device.

The invention achieves the above-identified object by providing a wireless access point device for facilitating an electronic device to access a wireless local area network. The wireless access point device includes a control circuit and a media port. The control circuit is used for controlling the wireless access point device and generating security data for authentication between the electronic device and the wireless access point device. When the media port is electrically connected to the electronic device, the wireless access point device, in response to a triggering event, transmits a signal indicating the security data to the electronic device through the media port, in order to enable the electronic device to configure the electronic device according to the security data to wirelessly access the wireless local area network via the wireless access point device.

The invention achieves the above-identified object by providing a method for configuring an electronic device to communicate with a wireless local area network via a wireless access point device. The method includes the following steps. A wired connection is made between a media port of the wireless access point device and a media port of the electronic device. A triggering event is then made for requesting data to set up the electronic device to communicate with the wireless local area network. The wireless access point device generates security data for authentication between the wireless access point device and the electronic device. The security data is transmitted via the media port of the wireless access point device in response to the triggering event. The security data is then received via the media port of the electronic device. After that, the electronic device is configured according to the security data in order to wirelessly access the wireless local area network via the wireless access point device.

The invention achieves the above-identified object by providing a system for configuring a wireless local area network. The system includes a wireless access point device and an electronic device. The wireless access point device includes a control circuit and a first media port. The control circuit is used for controlling the wireless access point device and generating security data, and the first media port is for outputting a signal indicating the security data. The electronic device includes a second media port and a data processing circuit. The second media port is operable in a normal mode for media data and in a set-up mode selectively. When the second media port is electrically connected to the first media port in the set-up mode, the electronic device, through the second media port, receives the signal indicating security data. The data processing circuit configures the electronic device according to the security data in order to wirelessly access the wireless local area network via the wireless access point device. After the second media port is electrically connected to the first media port in the set-up mode, the wireless access point device, in response to a triggering event, outputs the security data to the electronic device through the first media port.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) illustrates a typical wireless local area network.

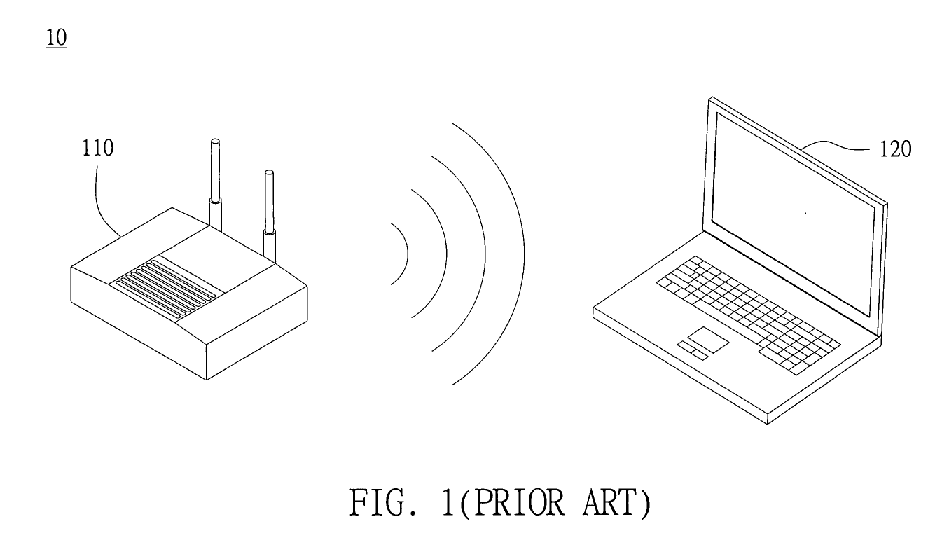

FIG. 2 shows a system for configuring an electronic device to communicate with a wireless local area network via an access point, according to a preferred embodiment of the invention.

FIG. 3 is a flowchart of a method for configuring an electronic device to communicate with a wireless local area network via an access point, according to the preferred embodiment of the invention.

### DETAILED DESCRIPTION OF THE INVENTION

According to an embodiment of the invention, an electronic device is enabled to set up itself automatically for access to a wireless local area network (WLAN) after acquiring security information from an access point (AP) by electrically connecting, preferably temporarily, the electronic device to the AP. This approach leads to a simplified system and method for configuring the electronic device to communicate with the WLAN via the AP, and avoids the inconvenience of requiring a user to manually input various complicated parameters related to security and authentication for configuring the electronic device to access a WLAN.

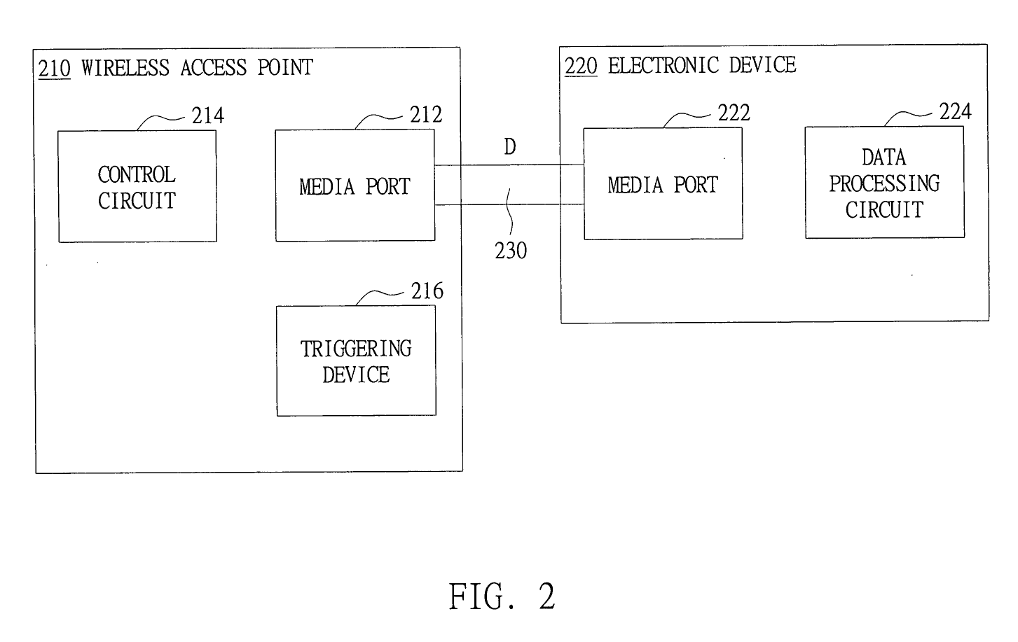

Referring to FIG. 2, a system for configuring an electronic device to communicate with a WLAN via an AP is shown in block diagram form, according to a preferred embodiment of the invention. The WLAN 20 includes an AP 210 and an electronic device 220. The AP 210 includes a triggering device 216, a control circuit 214, and a media port 212. The control circuit 214 is used for controlling the AP 210 and generating security data D for identifying the AP 210 and the electronic device 220. The triggering device 216 is employed for triggering the AP 210, in response to a triggering event, in order to output a signal indicating the security data D to the electronic device 220 by the media port 212. The triggering event, for example, is generated with respect to an action by a user. For example, the AP 210 includes a device for a user to touch, such as a button, key, or a touch pad, in order to generate the triggering event. In one example, a button is disposed on the AP 210 and the user presses the button to generate the triggering event.

The electronic device 220 is a device for processing data and can be configured as a wireless client, such as an audio-video device, a computer system, a personal digital assistant (PDA), a media adapter, or an information appliance, which may include built-in circuitry for WLAN access or is equipped with a WLAN adapter. The electronic device 220 includes a media port 222 and a data processing circuit 224. The media port 222 of the electronic device 220 can be coupled to the media port 212 of the AP 210 via a transmission line 230 so that the electronic device 220 receives the signal indicating the security data D through its media port 222. After the electronic device 220 receives the signal indicating the security data D completely, it is preferred to disconnect the transmission line 230 from the media port 222 of the electronic device 220 and the media port 212 of the AP 210, in order for a user to move freely with the electronic device 220, for example. According to the received security data D and a setup program for configuring the electronic device 220 as a WLAN client, the data processing device 224 then configures the electronic device 220, wherein the electronic device 220 may include a memory for storing the setup program. When configuring the electronic device 220 for access to WLAN completes, the electronic device 220 can communicate with the WLAN wirelessly via the AP 210.

The media port 212 and media port 222 are units including hardware and associated circuitry that link one device with another. For examples, the media ports can be implemented as audio ports, video ports, universal serial bus (USB) ports, game ports, or auxiliary ports, where analog or digital signals are transmitted or received. When an electronic device is being set up for communication with a wireless local area network, or during a set-up mode, the media port 222 of the electronic device 220 is used for receiving the signal indicating security data. After the set-up is completed, the media port 222, such as an audio port, can operate in a normal mode for receiving or outputting a signal indicating media data, such as an audio signal indicating audio data. That is, the media port 222 can be operable in a normal mode and a set-up mode selectively, wherein the media port 222 is for media data, such as audio data, image data, or video data, in the normal mode. On the other hand, the media port 212 of the AP 210 can be operable in various modes, in the way as the media port 222 does, for example. In addition, the media 212 of the AP 210 can also be a dedicated port for transmission of the security data D to any client device connected to the AP 210 for the set-up of communication to the wireless local area network.

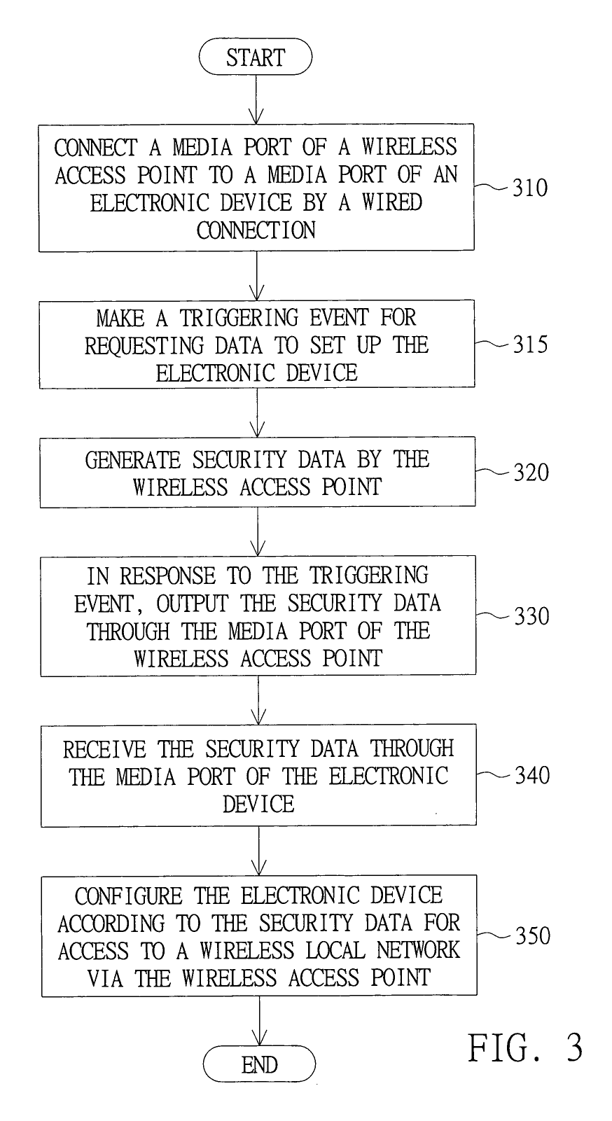

FIG. 3 is a flowchart of a method for configuring an electronic device to communicate with a wireless local area network via an access point, according to the preferred embodiment of the invention. The method is for use in a system for configuring an electronic device to communicate with a WLAN via an AP, according to the invention, such as the system 20 shown in FIG. 2. The method includes electrically connecting the media port 212 of the AP 210 to the media port 224 of the electronic device 220, as indicated in step 310. In step 315, a triggering event is made, indicating a request for security data in order to set up a client device, i.e. the electronic device, connected to the AP, wherein the triggering event can be made by a user pressing a key or button on the AP, for example. In step 320, the AP 210 generates security data D. The AP 210, in step 330, transmits a signal indicating the security data D through the media port 212 of the AP 210 in response to the triggering event. In step 340, the electronic device 220 receives the signal through the media port 222 of the electronic device 220. In this way, the electronic device 220 acquires the security data indicated by the received signal. After that, the electronic device 220 configures itself according to the acquired security data in order to wirelessly access the WLAN via the AP 210.

In one example, if the media port 212 of the AP 210 and the media port 222 of the electronic device 220 are audio ports, the transmission line 230 is an audio cable. When the electronic device 220 is configured to communicate with the WLAN via the AP 210, the setup program for a WLAN client creates a message window as an indication for instructing the user to use the audio cable to connect the media port 212 of the AP 210 to the media port 222 of the electronic device 220. After the audio cable is connected properly, another message window is displayed as an indication for instructing the user to trigger the triggering device 216, for example by an event of pressing a button, key, or a touch response device disposed on the AP 210.

After the triggering device 216 is triggered, the AP 210 generates security data D, and transmits a signal indicating the security data D to the electronic device 220 through the audio cable. A message window is displayed for instructing the user to disconnect the audio cable from the media port 212 and the media port 222, for example, after the signal is received or after the electronic device is configured successful. In another example, coupling the audio cable to the media port 212 and the media port 222 can act as an event to activate the triggering device 216 in order to transmit the signal indicating the security data D to the electronic device 220 when the setup program is involved. In further example, the AP 210 can generate the security data D before the triggering event is made. For example, when the AP 210 is reset, the AP 210 can automatically setup all the required parameters for infrastructure mode including the security data D.

The electronic device 220 acquires the security data D according to the signal received through the audio cable, and the WLAN client setup program configures the electronic device 220 for access to the WLAN according to the acquired security data. Specifically, the signal transmitted by the AP 210 is compliant with a protocol or standard. For instance, RS-232 signal protocol can be adopted to operate in a low baud rate to ensure safety in transferring the security data, and error-handling scheme, such as checksum or CRC code, can be employed. After the electronic device 220 is configured completely as a wireless client, the electronic device 220 can communicate with the WLAN via the AP 210.

The security data D generated by the AP 210 is data for use in authentication and/or encryption, such as SSID and security key. According to IEEE 802.1X series standards, an SSID is used for authentication and differentiating one WLAN from another. All access points and all devices attempting to connect to a specific WLAN must use the same SSID. The security key, such as WEP key, WPA key, or other keys proposed in IEEE 802.11i, is employed in data encryption with different levels of security to provide secure wireless transmission between the electronic device 220 and the AP 210. The WLAN client setup program uses the security data, such as SSID, WEP or WPA key, to configure the electronic device 20 to wirelessly access to the WLAN via the AP 210.

As an example, the electronic device 220 is an audio-video system support WLAN compliant with IEEE802.1X standards, and a media server for providing audio and video is connected to a WLAN linked to the AP 210. After configured in the manner as illustrated in the above embodiment, the wireless audio-video system can wirelessly access the media server, receive a data stream or file of a movie or song to reproduce, wherein the user does not need to manually input various parameters for WLAN access.

As disclosed above, the system and method for configuring an electronic device to communicate with a WLAN have the following advantages.

First, wireless sniffing for security data is avoided during the setup for a wireless client device because a wired connection is employed to transfer security data generated by an AP to the client device.

Second, it is easy to configure and use a wireless client device. Security data can be automatically generated by an AP and transferred to the client device for setting, with no need of manually entering the security data at the client device. Users can configure the client device for access to a WLAN in a simple and easy manner.

While the invention has been described by way of examples and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An electronic device to access a wireless local area network via a wireless access point device, the electronic device comprising:
a media port selectively operable in a normal mode for media data and in a set-up mode, wherein in the set-up mode, when the media port is electrically connected to the wireless access point device, the electronic device, through the media port, receives security data from the wireless access point device, wherein the security data include an identifier for authentication between the electronic device and the wireless access point device; and
a data processing circuit for configuring the electronic device according to the security data to wirelessly access the wireless local area network via the wireless access point device.

2. The electronic device according to claim 1, wherein the electronic device further comprises a memory for storing a setup program, the data processing circuit executes the setup program to configure the electronic device according to the security data in order to access the wireless local area network via the wireless access point device.

3. The electronic device according to claim 2, wherein the setup program is a wireless local area network client setup program.

4. The electronic device according to claim 2, wherein the data processing circuit executes the setup program to give an indication to a user to connect the media port electrically to the wireless access point device in order to receive the security data from the wireless access point device.

5. The electronic device according to claim 4, wherein the data processing circuit executes the setup program to further give an indication to the user, after the media port is electrically connected to the wireless access point device, to trigger the wireless access point device to transmit the security data so that the electronic device receives the security data from the wireless access point device.

6. The electronic device according to claim 1, wherein the identifier is a service set identifier (SSID).

7. The electronic device according to claim 1, wherein the security data include a key for encrypted data transmission between the wireless access point device and the electronic device.

8. The electronic device according to claim 7, wherein the key is a wired equivalent privacy (WEP) key.

9. The electronic device according to claim 7, wherein the key is a Wi-Fi protected access (WPA) key.

10. The electronic device according to claim 1, wherein the media port is electrically connected to the wireless access point device via a transmission line for receiving the security data.

11. The electronic device according to claim 10, wherein the media port is disconnected from the transmission line after the security data are received.

12. The electronic device according to claim 10, wherein the media port is an audio port and the transmission line is an audio cable.

13. The electronic device according to claim 1, wherein the media port is an audio port.

14. The electronic device according to claim 1, wherein the electronic device is an audio-video device.

15. The electronic device according to claim 1, wherein the electronic device is a media adapter.

16. The electronic device according to claim 1, wherein the electronic device is an information appliance.

17. A wireless access point device for facilitating an electronic device to access a wireless local area network, the wireless access point device comprising:
a control circuit for controlling the wireless access point device and generating security data for authentication between the electronic device and the wireless access point device; and
a media port, wherein after the media port is electrically connected to the electronic device, the wireless access point device, in response to a triggering event, transmits the security data to the electronic device through the media port in order to enable the electronic device to configure the electronic device according to the security data to wirelessly access the wireless local area network via the wireless access point device.

18. The wireless access point device according to claim 17, further comprising a triggering device, in response to the triggering event, for triggering the wireless access point device to transmit the security data via the media port to the electronic device in order to enable the electronic device to configure the electronic device according to the security data to wirelessly access the wireless local area network via the wireless access point device.

19. The wireless access point device according to claim 18, wherein wireless access point device further includes a device for a user to touch in order to generate the triggering event.

20. The wireless access point device according to claim 17, wherein security data include a service set identifier (SSID).

21. The wireless access point device according to claim 17, wherein the security data include a key for encrypted data transmission between the wireless access point device and the electronic device.

22. The wireless access point device according to claim 21, wherein the key is a wired equivalent privacy (WEP) key.

23. The wireless access point device according to claim 21, wherein the key is a Wi-Fi protected access (WPA) key.

24. The wireless access point device according to claim 17, wherein the media port is electrically connected to the electronic device via a transmission line for transmitting the security data to the electronic device.

25. The wireless access point device according to claim 24, wherein the media port is disconnected from the transmission line after the security data are received.

26. The wireless access point device according to claim 24, wherein the transmission line is an audio cable.

27. The wireless access point device according to claim 17, wherein the media port is an audio port.

28. A method for configuring an electronic device to communicate with a wireless local area network via a wireless access point device, the method comprising:
connecting a media port of the wireless access point device to a media port of the electronic device by making a wired connection;
making a triggering event for requesting data to set up the electronic device to communicate with the wireless local area network;
generating security data by the wireless access point device, the security data being used for authentication between the wireless access point device and the electronic device;
in response to the triggering event, transmitting the security data via the media port of the wireless access point device;
receiving the security data via the media port of the electronic device; and
configuring the electronic device according to the security data in order to wirelessly access the wireless local area network via the wireless access point device.

29. The method according to claim 28, further comprising:
disconnecting the wired connection after the security data are received.

30. The method according to claim 28, wherein the media port of the wireless access point device and the media port of the electronic device are respective audio ports thereof.

31. The method according to claim 28, wherein the security data include a service set identifier (SSID).

32. The method according to claim 28, wherein the security data include a key for encrypted data transmission between the wireless access point device and the electronic device.

33. The method according to claim 32, wherein the key is a wired equivalent privacy (WEP) key.

34. The method according to claim 32, wherein the key is a Wi-Fi protected access (WPA) key.

35. A system for configuring a wireless local area network, comprising:
a wireless access point device comprising:
a control circuit for controlling the wireless access point device and generating security data; and
a first media port for outputting the security data;
an electronic device comprising:
a second media port selectively operable in a normal mode for media data and in a set-up mode, wherein in the set-up mode, when the second media port is electrically connected to the first media port, the electronic device, through the second media port, receives the security data generated by the wireless access point device; and
a data processing circuit for configuring the electronic device according to the security data in order for the electronic device to wirelessly access the wireless local area network via the wireless access point device;
wherein after the second media port is electrically connected to the first media port in the set-up mode, the wireless access point device, in response to a triggering event, outputs the security data to the electronic device through the first media port;
wherein the security data include an identifier for authentication between the wireless access point device and the electronic device.

36. The system according to claim 35, wherein the wireless access point device further comprises a triggering device, in response to the triggering event, for triggering the wireless access point device to transmit the security data via the first media port to the electronic device in order to enable the electronic device to configure the electronic device according to the security data to wirelessly access the wireless local area network via the wireless access point device.

37. The system according to claim 35, wherein the identifier is a service set identifier (SSID).

38. The system according to claim 35, wherein the security data include a key for encrypted data transmission between the wireless access point device and the electronic device.

39. The system according to claim 38, wherein the key is a wired equivalent privacy (WEP) key.

40. The system according to claim 38, wherein the key is a Wi-Fi protected access (WPA) key.

41. The system according to claim 35, wherein the second media port of the electronic device is an audio port thereof.
